(19) United States
(12) Patent Application Publication
(10) Pub. No.: US 2010/0313770 A1
(43) Pub. Date: Dec. 16, 2010

(54) MARKING DEVICE FOR MARKING BALLS

(76) Inventor: Annette Lehmann, St. Niklausen (CH)

Correspondence Address: MCCORMICK, PAULDING & HUBER LLP, CITY PLACE II, 185 ASYLUM STREET, HARTFORD, CT, 06103, US

(21) Appl. No.: 12/811,748

(22) PCT Filed: Dec. 11, 2008
(86) PCT No.: PCT/EP08/67313

§ 371 Date: Sep. 1, 2010

(30) Foreign Application Priority Data
Jan. 4, 2008 (CH) 00007/08

(51) Int. Cl. B41F 17/30

(52) U.S. Cl. 101/35

(57) ABSTRACT

Marking device (10) comprising a housing, a stamp pad (13) and an ink reservoir (15), wherein the ink reservoir (15) is in fluid connection with the stamp pad (13). The marking device (10) comprises an interchangeable template (12) which is arranged in a lower part (11.1) of the housing in such a way that the stamp pad (13) and the ink reservoir (15) are arranged relative to one another below the template (12) in the lower part (11.1) of the housing. Part of the stamp pad (13) is accessible through an opening (12.1) in the template (12). The template (12) can be fastened manually in the lower part (11.1) of the housing. Furthermore, the housing comprises an upper part (11.2) which can be removed manually in order to allow access to the opening (12.1) in the template (12). When the housing is in an opened state, the lower part (11.1) of the marking device (10) can be pressed by way of the opening in the template (12) against a ball (20), or a ball (20) can be pressed against the opening (12.1) in the template (12).

The present invention relates to marking devices having a housing, a stamp pad, and an ink reservoir, the ink reservoir having a fluid connection to the stamp pad.

Tennis players typically mark their tennis balls in order to avoid confusion with the balls of other players. The markings are frequently made using felt-tip pens. It has been shown that the marking is often not permanent, or that the marking may only be differentiated with difficulty from markings on balls of other players.

Markings are also applied in the case of other balls. This is performed, on the one hand, to avoid confusion of the balls and, on the other hand, to mark balls which are only used in a hall, for example.

Up to this point, there has been no satisfactory solution which allows the simple and permanent marking of balls by the user or player.

The object of the invention is therefore to provide a solution which allows simple and permanent marking of balls by the user or player.

According to the invention, a marking device is provided, which has a replaceable template, which is situated in a lower part of the housing in such a way that the stamp pad and the ink reservoir are situated one over the other below the template in the lower part of the housing. A part of the stamp pad is accessible through an opening of the template. The template can be manually fastened in the lower part of the housing and the housing comprises an upper part, which can be manually removed, in order to allow access to the opening of the template. The lower part of the marking device can be pressed with the opening of the template against the ball, or a ball can be pressed against the opening of the template.

Balls can be marked easily, rapidly, and permanently by this approach. It can be ensured by replacement of the template that balls of various persons can be differentiated. The quality of the markings is uniform and visually appealing.

Further details and advantages of the invention are described hereafter on the basis of exemplary embodiments and with reference to the drawing. In the figures:

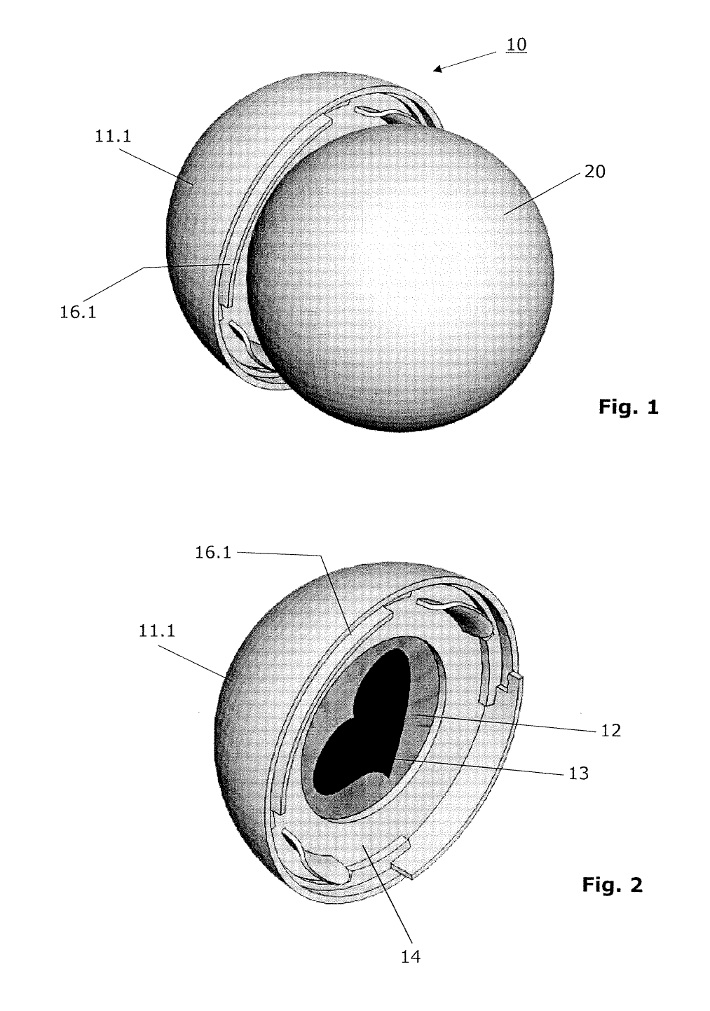

FIG. 1 shows a first embodiment of the invention in a perspective view, a tennis ball being pressed against the lower part of the marking device in the moment shown;

FIG. 2 shows a perspective view of the lower part of the first embodiment of the invention;

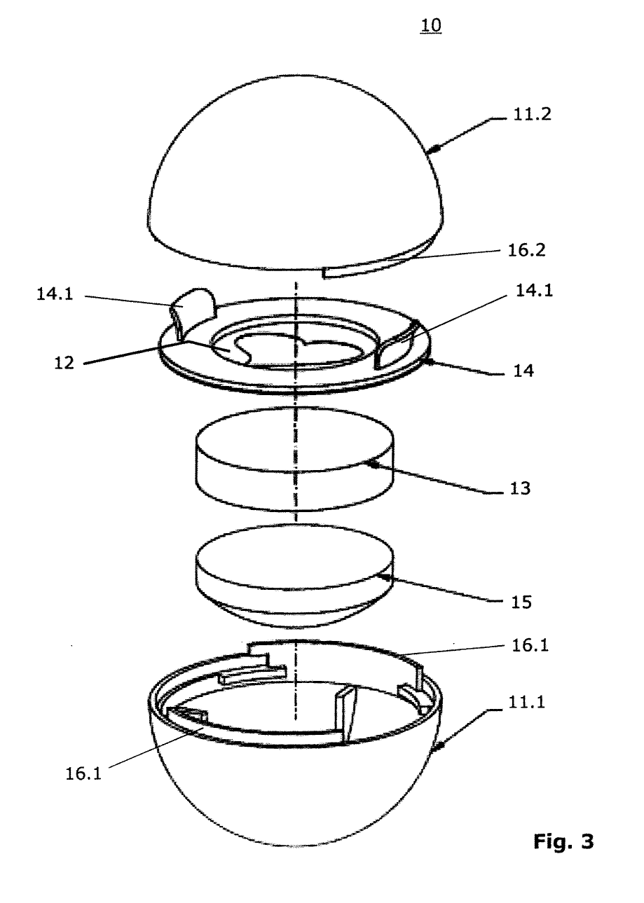

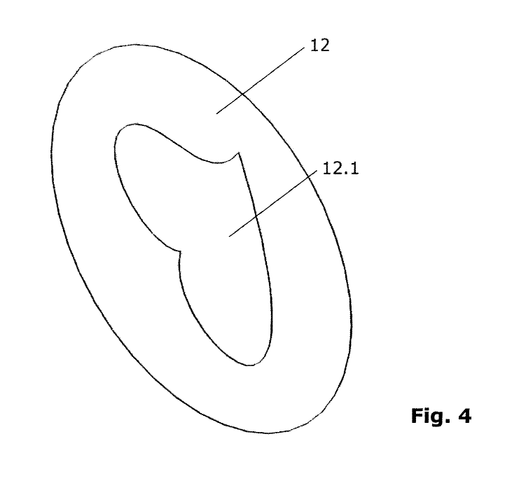

FIG. 3 shows an exploded view of the first embodiment of the invention;

FIG. 4 shows a perspective view of a template according to the invention.

### DETAILED DESCRIPTION

A preferred embodiment of the invention is described hereafter, which is especially designed for marking tennis balls 20. The invention can also be used for marking other balls (soccer balls, hand balls or volleyballs, golf balls, etc.), however. The dimensions of the marking device 10 are preferably selected accordingly in this case.

The marking device 10 according to the invention has a two-part housing having a lower part 11.1 and an upper part 11.2. A type of stamp pad 13 and an ink reservoir 15, which are situated in the sequence shown in FIG. 3 in the lower part 11.1 of the housing, are located in the lower part 11.1. The ink reservoir 15 has a fluid connection to the stamp pad 13, so that sufficient ink liquid, which is stored in the ink reservoir 15, can always flow or be sucked into the stamp pad. The configuration and embodiment of these elements is similar as in the case of a stamp pad, it being important that ink does not run out of the stamp pad 10 even when inverted.

The stamp pad 13 is delimited on top by a replaceable template 12, which is situated in the lower part 11.1 of the housing so that the stamp pad 13 and the ink reservoir 15 are situated one over the other below the template 12 in the lower part 11.1 of the housing. A part of the stamp pad 13 is accessible through an opening 12.1 (which is heart-shaped, for example) of the template 12, as indicated in FIG. 2. The stamp pad 13 is shown black in FIG. 2.

The template 12 can be manually fastened in the lower part 11.1 of the housing. The template 12 is preferably fastened by a ring 14 or a clamp on the lower part 11.1. The template 12 can be welded, glued, or press-fit fixedly with the ring element 14. However, it is also possible to lay the template 12 loosely on the stamp pad 13 and then to clamp it fixedly using the ring element 14. The embodiment having the loosely inserted template 12 has the advantage that the template 12 itself can be cut to size. Using scissors or a punch tool, a symbol can be cut or punched out of the template 12. Symmetrical symbols can also be cut out by folding together the template 12, as in the case of a scissors cut.

The housing further comprises an upper part 11.2, which can be manually removed, in order to allow access to the opening 12.1 of the template 12. If the upper part 11.2 has been removed, the lower part 11.1 of the marking device 10 can be pressed with the opening 12.1 of the template 12 against the ball 20, or a ball 20 can be pressed against the opening 12.1 of the template 12, as shown in FIG. 1.

The dimensions of the housing 11.1, 11.2 and the size and placement of the opening 12.1 are selected so that the ball 20 presses with its shell or its jacket a small distance into the opening 12.1, in order to come into contact with stamp pad 13 and the ink which is in the stamp pad 13. In the example shown, a black, heart-shaped imprint is applied to the ball 20. Other symbols may also be used, however.

The lower part 11.1 of the housing and the upper part 11.2 of the housing preferably each have the form of a hollow hemisphere. The housing is thus similar to a tennis ball 20, above all when it is assembled.

The upper part 11.2 and the lower part 11.1 preferably have bayonet closure elements 16.1, 16.2, as may be seen in FIGS. 1 through 3. The upper part 11.2 and the lower part 11.1 may be connected to one another or disconnected from one another by a manual rotating movement. The connection using bayonet closure elements 16.1, 16.2 has the advantage that both halves 11.1, 11.2 of the housing may be fastened to one another securely and easily. Running out of the ink or soiling of pockets in which the marking device 10 is stored can thus be prevented.

The template 12 is preferably seated in a ring element 14, which is preferably fastenable in the lower part 11.1 by a rotating movement. However, it is also conceivable to offer a ring element 14, which comprises the template 12 as an integral component. The marking device 10 is preferably offered having multiple different templates 12, or having multiple different rings 14 having templates 12.

The ring element 14 can have small grip elements 14.1, which may also be used as guide elements 14.1 or centering elements, for example, in order to achieve centering of the ball 20 when it is pressed against the device. The grip elements 14.1 allow the ring element 14 to be grasped using the fingers and inserted or clamped in the lower part 11.1. These grip elements 14.1 are shown as tongue-shaped tabs in FIG. 2, which press tangentially against a ball 20, in order to guide it. In another embodiment, the ring element 14 can be held using the grip elements 14.1 and screwed into the lower part 11.1. The screwing in can be performed using a thread or a bayonet closure.

The template 12 is preferably seated concentrically to a central axis of the sphere, which is formed from lower part 11.1 and upper part 11.2 of the housing. It is thus ensured that the opening 12.1 of the template 12 also lies centrally. The template 12 preferably has an easily stretchable film or diaphragm, which is designated here as a diaphragm for simplicity. This diaphragm can preferably be rolled up or folded. Diaphragms which may be cut using scissors or punched out using a punch tool are particularly preferred. The opening 12.1 can be defined in this diaphragm.

According to a further embodiment of the invention, the template is delivered having a diaphragm without opening 12.1. The user can thus produce his own opening 12.1 in the diaphragm (e.g., using scissors or a punch tool).

Waterproof ink is preferably used for marking or printing balls. The ink reservoir 15 is therefore especially designed to receive waterproof ink.

The diameter of a tennis ball is between 6.35 cm and 6.67 cm. The stamp 10 is distinguished in that each of the hemispheres 11.1, 11.2 has a diameter which is greater than 6 cm and less than 10 cm.

The diameter of the stamp housing 11.1, 11.2 is preferably approximately 10 to 20% greater than the diameter of the ball 20 to be marked. This specification applies for small balls 20. In the case of soccer balls, the marking device can be significantly smaller than the ball itself.

The marking device 10 thus has a housing 11.1, 11.2, a stamp pad 13, and an ink reservoir 15, the ink reservoir 15 having a fluid connection to the stamp pad 13. The marking device 10 has a replaceable template 12, which is situated in a lower part 11.1 of the housing so that the stamp pad 13 and the ink reservoir 15 are seated one over the other below the template 12 in the lower part 11.1 of the housing. A part of the stamp pad 13 is accessible through an opening 12.1 of the template 12. The template 12 can be fastened manually in the lower part 11.1 of the housing. Furthermore, the housing comprises an upper part 11.2, which can be manually removed in order to allow access to the opening 12.1 of the template 12. In the open state, the lower part 11.1 of the marking device 10 can be pressed with the opening of the template 12 against a ball 20, or a ball 20 can be pressed against the opening 12.1 of the template 12.

In addition to the exchange/replacement of the template 12, the stamp color in the stamp pad can also be changed as needed. For example, green, blue, and red hearts can be stamped or applied using the template 12 shown in FIG. 4 by replacing the stamp color or the stamp pad. Other symbols can also be stamped on upon use of another template 12 having another symbol.

Numerous possible combinations are provided by the replacement/exchange of the template 12 (for example, having other symbols) and the stamp color or the stamp pad 13.

In a further embodiment of the invention, the two tennis ball stamp halves (i.e., the lower part 11.1 and the upper part 11.2) are constructed identically. In this case, both parts 11.1, 11.2 contain a ring element 14, a stamp pad 13, an ink reservoir 15, and a template 12. Therefore, two stamp possibilities (one per “hemisphere” 11.1, 11.2) are available per stamp 12.

The lower parts 11.1 and upper parts 11.2 may be freely replaceable and may therefore be assembled arbitrarily thanks to the bayonet closure.

According to a further embodiment of the invention, the lower part 11.1 or the upper part 11.2 can be internally designed so that one or more templates 12 may be stored in this part. If the templates 12 are thin and flexible (possibly rubber-like) diaphragm-like elements, means may be provided on the ring element 14 for clamping or stretching the template 12. This type of template 12 can preferably have a diameter which is somewhat greater than the diameter of the ring element 14. To clamp the template 12, the ring element 14 is laid on the template 12 and the template 12 is grasped so that its outer edge runs upward. When the ring element 14 is screwed into one of the sphere halves 11.1 or 11.2, the outer edge of the template 12 is clamped/fixed in the intermediate space between the ring element 14 and the inner wall of the corresponding lower part 11.1 or upper part 11.2.

The lower part 11.1 and the upper part 11.2 and/or the template 12 are preferably manufactured from injection-molded plastic, and/or the lower part 11.1 and the upper part 11.2 and/or the template 12 are produced in the injection-molding method. Thin and flexible (rubber-like) diaphragms are particularly preferred as the template 12.

1-10. (canceled)

11. A marking device (10) comprising a housing, a stamp pad (13), and an ink reservoir (15), the ink reservoir (15) having a fluid connection to the stamp pad (13), and wherein
the marking device (10) has a replaceable template (12), which is situated in a lower part (11.1) of the housing so that the stamp pad (13) and the ink reservoir (15) are situated one over the other below the template (12) in the lower part (11.1) of the housing, a part of the stamp pad (13) being accessible through an opening (12.1) of the template (12),
the template (12) can be fastened in the lower part (11.1) of the housing and manually,
the housing has an upper part (11.2), which can be manually removed in order to allow access to the opening (12.1) of the template (12), in order to be able to press the lower part (11.1) of the marking device (10) with the opening of the template (12) against a ball (20), or to be able to press a ball (20) against the opening (12.1) of the template (12), and
wherein said device (10) comprises a ring element (14), which is preferably fastenable in the lower part (11.1) by a rotating movement.

12. The marking device (10) according to claim 1, characterized in that the lower part (11.1) of the housing and the upper part (11.2) of the housing each have the form of a hollow hemisphere.

13. The marking device (10) according to claim 1, characterized in that the upper part (11.2) and the lower part (11.1) have bayonet closure elements (16.1, 16.2), upper part (11.2) and lower part (11.1) being able to be connected to one another or disconnected from one another by a manual rotating movement.

14. The marking device (10) according to claim 1, characterized in that the template (12) is seated in said ring element (14).

15. The marking device (10) according to claim 4, characterized in that the ring element (14) has grip elements (14.1), in order to be able to insert, clamp, or screw the ring element (14) into the lower part (11.1).

16. The marking device (10) according to claim 1, characterized in that it has multiple templates (12) having different shaped openings (12.1), which are replaceable.

17. The marking device (10) according to claim 1, characterized in that the ink reservoir (15) is designed to receive waterproof ink.

18. The marking device (10) according to claim 1, characterized in that it is designed for marking tennis balls (20), the ink reservoir (15) being filled with waterproof ink.

19. The marking device (10) according to claim 2, characterized in that each of the hemispheres has a diameter which is larger than 6 cm and smaller than 10 cm.

20. The marking device (10) according to claim 2, characterized in that both hemispheres are implemented identically.
